(19) United States
(12) Patent Application Publication
(10) Pub. No.: US 2010/0151198 A1
(43) Pub. Date: Jun. 17, 2010

(54) Roofing Material

(76) Inventor: Amir G. Khan, Wayne, NJ (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/334,091

(22) Filed: Dec. 12, 2008

(51) Int. Cl. E04D 5/12; E04D 5/02; B05D 1/12; D06N 5/00; B32B 1/00

(52) U.S. Cl. 428/144; 427/186; 428/403; 428/407

(57) ABSTRACT

A roofing material and process for making same has a granular surface formed from coated granules embedded in an upper layer of modified asphalt. The granules are coated with a coloring composition and with a hydrophobic material. To assure adequate color intensity and a physically strong attachment of the coating on the granule, multiple layers of coloring composition are applied to the granules and are fired at a high temperature for a significant period of time. High reflectivity can be achieved using the coated granules, as well as a high degree of hydrophobicity to aid in shedding water, in particular acidic rainwater to increase roofing membrane performance and useful life.

### FIELD OF THE INVENTION

The present invention relates to roofing materials and more particularly to bituminous roofing materials having granules, such as crushed stone, embedded in an upper side thereof.

### BACKGROUND OF THE INVENTION

Bituminous (asphalt) roofing membranes have been known and used for many years for forming waterproof roofs for buildings, both residential and commercial. Most modern bituminous roofing membranes are formed around a fabric sheet made from polyester, fiberglass or the like. The fabric sheet is coated with bitumen (asphalt), that has been modified with one or more modifiers such as Atactic PolyPropylene (APP), Amorphous Poly Alpha Olefin (APAO), Thermoplastic Polyolefin (TPO), Styrene-Butadiene-Styrene (SBS), Styrene-Ethylene-Butadiene-Styrene (SEBS), or synthetic rubber. The modifiers change the properties of the asphalt to increase its utility as a roofing membrane, e.g., to make it more elastic, have greater flexibility at low temperatures and greater heat resistance at high temperatures to prevent softening/flow and deformation from mechanical forces, such as those associated with maintenance personnel walking on the roofing membrane. A roofing membrane may be formed of a laminate of a plurality of types of modified asphalt, e.g., a layer of a first type may be formed on the bottom surface that has an increased adhesive grip on the roofing underlayment and a different layer may be used on the upper surface that has enhanced weather resistance, etc. Adhesive layers may be applied to the membrane to allow the membrane to adhere to a substrate and/or to adhere to an adjacent sheet of roofing membrane. The adhesive may be applied to limited areas, e.g., the edge, where the roofing membrane is intended to overlap. There are a variety of ways for attaching roofing membranes to roofs, such as the application of an adhesive that can be softened by a torch, by “hot mopping” molten asphalt composition to the roof upon which the roofing membrane is applied and adhered, nailing (in the case of shingles) and self-adherent adhesives.

Bituminous roofing frequently employs an upper surface embedded with granules. These granules impart color, texture, foot/shoe slip-resistance and weather resistance to the roofing membrane. It has been recognized that the color of a roof has a significant impact on the absorbance/reflection of solar energy and therefore has a significant effect on the amount of energy required to heat/cool a building. In hot climates, roofs with greater reflectivity can reduce energy costs related to air conditioning (cooling). In recognition of this effect, government entities have passed laws and regulations pertaining to the color/reflectivity of roofs and established incentives and criteria for selecting roofing materials that result in lowered energy demand. Ratings exist (Energy Star®) to characterize roofing light/heat reflectivity relative to that irradiating a given surface—as a fraction or percentage.

The reflectivity of a given crushed stone granule surface may be increased by applying a reflective coating to the granule surface of a finished roofing membrane, e.g., by painting the coating on the granular surface. This may be conducted after the roof has been installed on a building, or may be applied to the roofing membrane during manufacture in the factory. If applied on-site, painting a roof is a difficult and laborious process due to roof height, slope and weather conditions and the quality of the finished product is dependent upon the skill and reliability of the workman. A coating applied at the factory also has associated costs and limitations. For example, the coating is applied to heavy and bulky roofing material that typically needs to be dried/cured before the roofing material can be packaged or rolled, significantly complicating the manufacturing process and apparatus needed. In addition, coatings applied to surfaces of roofing material tend to form a relatively fragile layer e.g., where the coating bridges between granules and between granules and the asphalt layer in which they are embedded. In the case of roll roofing, when a coating is applied at the factory and the resultant coated roofing is rolled for storage and transport, the coating can crack, resulting in the degradation of the roofing material. Similarly, bending of pre-coated roofing shingles during installation on a roof can result in cracking the previously applied coating.

In addition to color/reflectivity limitations of crushed stone used for making granular surfaces of roofing membranes, the granules also have a limited resistance to erosion when subjected to rainwater, and in particular acidic rainwater, which is common in many areas due to air pollution. Acidic rainwater can etch/dissolve roofing granules, diminishing their reflectivity and loosening their embedment within the asphalt layer, such that they may be displaced from the asphalt layer, e.g., when subjected to mechanical forces, such as wind, leaves, snow, rain and the foot traffic of maintenance personnel. In the latter instance, the loosening of granules can result in diminished traction for maintenance personnel.

Given the limitations of known methods and materials for forming roofing membranes with high reflectivity, durability and weather resistance, improved methods and materials remain desirable, e.g., methods and materials for increasing reflectivity, which are conveniently and safely implemented in the manufacturing setting and preserve roofing membrane flexibility. Furthermore, improvements in roofing materials that make them more resistant to the effects of acid rain remain desirable.

### SUMMARY OF THE INVENTION

The limitations of prior art roofing materials are overcome by the present invention which includes a roofing granule having a core with an outer surface. The outer surface of the roofing granule is coated. The independently coated granules can be pressed into an asphalt containing layer to form a granular surface. In accordance with a method of the invention, the coating is applied and cured. In accordance with another embodiment, the coating may be used to impart color and reflectivity to the core and may be applied in multiple layers, each layer being heat cured. In accordance with a further embodiment, the coated granule may be over-coated with a hydrophobic material.

### BRIEF DESCRIPTION OF THE FIGURES

FIG. 1 is a perspective, partially exploded view of a modified bituminous, laminated roofing membrane in accordance with an exemplary embodiment of the present invention.

FIG. 2 is an enlarged cross-sectional view of the roofing membrane of FIG. 1.

FIG. 3 is an enlarged cross-sectional view of granules used in the roofing membrane of FIGS. 1 and 2.

FIG. 4 is a diagram of a process in accordance with an exemplary embodiment of the present invention for making and using the granules of FIG. 3 in a roofing membrane.

### DETAILED DESCRIPTION OF THE INVENTION

FIG. 1 shows a roofing membrane 10 in accordance with an embodiment of the present invention. The roofing member has an inner sheet or mat 12 composed of polyester or fiberglass or other similar material from which a fabric may be made. Bottom and top layers 14, 16, respectively, of asphalt compound are laminated to opposing sides of the fabric mat 12. (For ease of visualization, the layers 12, 14, 16 are shown spaced apart.) The top layer 16 has a plurality of granules 18 disposed over the upper surface thereof forming a granular surface 18_{S}. Optionally, peripheral edges 20, 22 may be left smooth (without granules) to form a substrate for beads of adhesive 24, 26.

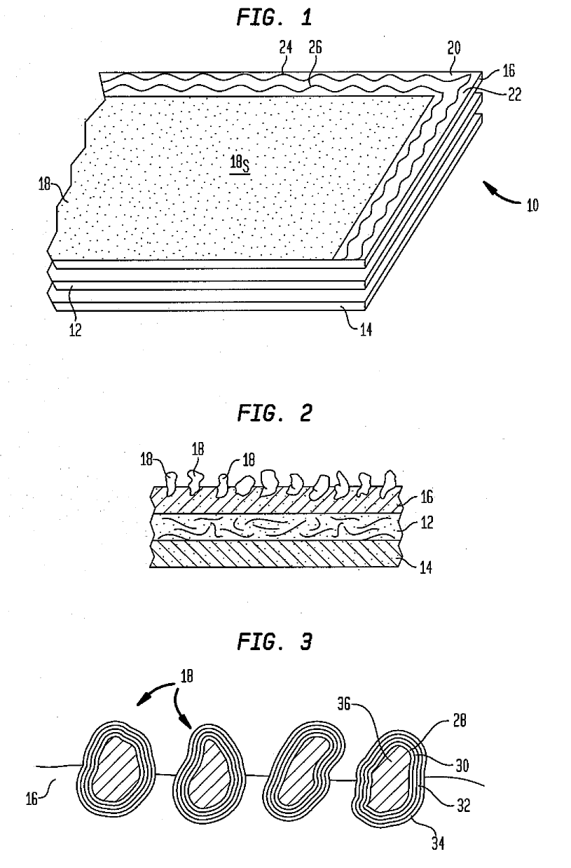

FIG. 2 shows an enlarged cross-section of the roofing membrane 10, with the layers 12, 14 and 16 laminated together. The granules 18 can be seen to be embedded in the upper layer 16 of modified asphalt compound.

FIG. 3 shows the granules 18 in cross-section and having a plurality of intermediate layers 28, 30, 32 of coloring composition and an outer hydrophobic layer 34 disposed over a granule core 36. The intermediate color composition layers 28, 30, 32 and outer hydrophobic layer 34 depicted are exaggerated in size relative to the granule core 36 for ease of illustration. In fact, color composition layers 28, 30, 32 are each approximately 1-2 mils thick. The hydrophobic layer 34 is also about 1-2 mils thick. The composition, preparation and properties of these granules is described below. FIG. 3 depicts a novel aspect of the present invention. More particularly, unlike a roofing system which employs granules embedded in asphalt that are over-coated with a painted-on coating, the granules themselves are independently coated. As shown in FIG. 3, there is no coating layer that bridges between granules 18 and the top asphalt layer 16. As a result, breakage of these absent, fragile and relatively brittle bridge portions of a coating layer is avoided, even if the roofing membrane is bent, e.g., when rolled for storage and shipment. The independently coated granules 18 of the present invention are thus free to move independently as constrained only by the top asphalt layer 16 and by the abutment of adjacent granules 18. It should be appreciated that FIG. 3 is diagrammatic as regards to showing a significant spacing between granules 18 (for ease of illustration). In actual roofing membrane 10, the spacing between granules 18 would be minimal and there would be overlap between granules 18 forming the granular surface 18_{S}, such that the underlying asphalt layer 16 would be largely obscured from view.

The outermost hydrophobic layer 34 of the granules 18 aids in shedding water, in particular rainwater, which may be acidic. Besides aiding in one of the basic purposes of roofing membranes 10 (shedding water), the hydrophobic layer 34 also protects the granules 18 from dissolution by rainwater (in particular, acidic rainwater) thereby preserving the color/reflectivity and the dimensions/surface smoothness of the granules 18. In one embodiment, the hydrophobic layer 34 is clear, such that the coloring composition layers 28, 30, 32 are visible through the hydrophobic layer 34. While the hydrophobic layer 34 is diagrammatically depicted as an outer “shell”, it is understood that at the atomic/molecular level level, the composition forming the hydrophobic layer 34 may penetrate into the layers 28, 30, 32 of color composition and bond therewith.

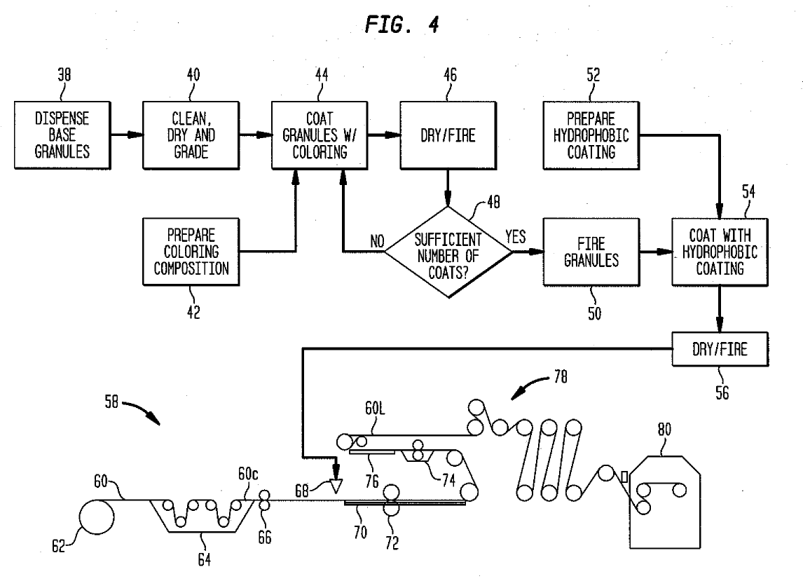

FIG. 4 shows a diagram of an exemplary process for forming a roofing membrane 10 in accordance with the present invention. Base granules (for forming the granular core 36 of granules 18), such as crushed rock, typically feldspar, basalt, or other types of rock, are mined and processed off site and may be obtained commercially from various quarries and suppliers of crushed stone, worldwide. The base granules (granular cores 36) are dispensed 38 into the production line, e.g., onto a conveyer belt or into buckets. The granular cores 36 are then optionally cleaned, dried and graded 40, e.g., by screening to eliminate granules that are too small or too large (which either pass or do not pass through appropriately sized screens.) and then sprayed with water and/or subjected to air flows to remove small particles of dust and dirt. These processes may be conducted by the supplier of the granules or may be done in-house. A liquid coloring composition to be applied to the granules is prepared 42. The final color of the granules 18 is determined by the color of the coloring composition (that forms layers 28, 30, 32), rather than the color of the granular core 36, leading to greater freedom in choosing the type of rock used in forming the granular core 36, based on its natural coloring.

An exemplary coloring composition contains the following constituents in the relative weight percentages shown:

Typical White Coating formulation

| | Actual | Range | |
|---|---|---|---|
| Raw Material | WT % | WT % | Description |
| Water | 14.09 | 5-40 | Vehicle for thickener |
| Ethylene/Propylene Glycol | 0.615 | 0.1-2.0 | anti freeze |
| Foam Master | 0.187 | 0.1-2.0 | defoamer |
| Latex Polymer | 23.55 | 7-40 | resin |
| Natrosol | 0.525 | 0.1-2.0 | thickener |
| Tamol 850 | 0.42 | 0.1-2.0 | dispersing agent |
| KTPP | 0.15 | 0.1-2.0 | dispersing agent |
| Titanium dioxide | 9 | 2-15 | pigment |
| Zinc Oxide | 4.5 | 1-9 | anti fungi agent |
| Aluminum Trihydrate | 9.75 | 5-30 | fire retardent |
| Calcium Carbonate | 9 | 2-15 | filler |
| 3.5-12 microns | | | |
| Attagel/Minugel | 0.54 | 0.1-5 | thickener |
| Nuosept 95 | 0.135 | 0.1-2.0 | preservative |
| Foam Master VF | 0.188 | 0.1-2.0 | defoamer |
| Latex Polymer | 23.55 | 7-40 | resin |
| Triton | 0.195 | 0.1-2.0 | dispersing agent |
| Aqua Ammonia | 0.105 | 0.1-2.0 | PH modifier |
| Texanol | 0.735 | 0.1-2.0 | cosolvent |
| Skane microbiocide | 0.135 | 0.1-2.0 | biocide |
| Sanicizer | 0.78 | 0.1-2.0 | plastisizer |

The coloring composition is prepared in accordance with the following exemplary method.

WITH MIXER OFF METER IN:
Water
TURN MIXER ON AT LOWEST SPEED AND ADD:
Ethylene/Propylene Glycol
ADD AND MIX AT LOWEST SPEED:
Foam Master VF
TURN OFF MIXER AND ADD BY OUTAGE:
Latex EC-1791
* ADD IN ORDER* TURN ON MIXER INCREASE SPEED
AS NEEDED TO MAINTAIN A VORTEX:
SLOWLY ADD INTO VORTEX AND MIX 5 MINUTES UNTIL
LUMP FREE:
Natrosol 250HR/ER52000
ADD INTO VORTEX:
Tamol 681
ADD INTO VORTEX:
Tamol 850
ADD INTO VORTEX:
KTPP
**INCREASE MIXER SPEED AND HEIGHT AS NEEDED
TO MAINTAIN VORTEX:
ADD INTO VORTEX:
TI02/CR828/R706/2310
ADD INTO VORTEX:
Zinc Oxide/XX503/Azo 66L
ADD INTO VORTEX:
Aluminum Trihydrate/C330/DH80/SB432
ADD INTO VORTEX:
Calcium Carbonate 3.5-12 microns
ADD SLOWLY INTO VORTEX:
Attagel 50/Minugel 400
ADD INTO VORTEX:
Nuosept 95
RINSE MIXER WITH HOSE:
Water
****MIX AT HIGH SPEED FOR 10 MINUTES* MAKE SURE
TEMPERATURE IS BELOW 120 F.
***CHECK GRIND MUST BE 3 MILS OR LESS***
***LET DOWN PHASE***
ADD INTO VORTEX:
FOAM MASTER VF
TURN OFF MIXER AND ADD BY OUTAGE:
Latex EC-1791
***TURN ON MIXER AND REDUCE SPEED TO REDUCE
AIR ENTRAINMENT:
ADD INTO VORTEX:
Triton X-405
ADD SLOWLY INTO VORTEX:
Aqua Ammonia 26%
ADD SLOWLY INTO VORTEX:
Texanol/NX795
ADD SLOWLY INTO VORTEX:
Skane M8 microbiocide
ADD INTO VORTEX:
Sanicizer 160
**MIX 5 MINUTES AND HAVE LAB TEST VISCOSITY AND PH**
***COVER BATCH WITH 1 GALLON OF WATER USING SPRAY HOSE**
***FILTER BATCH DURING PACKAGING***

TEST

SOLIDS WT %
DENSITY LBS/GAL
BROOKFIELD VISCOSITY 4D/5 rpm/77 F.
BROOKFIELD KU 77 F.
WET COLOR-DRAW DOWN
PH

Variations in the foregoing granule coloring composition and method for preparing same may be made, e.g., while the foregoing composition yields a white color, other colors may be obtained by substituting titanium dioxide with another pigment.

Given a supply of appropriately sized, cleaned and dry granular cores 36, they are coated 44 with the above-described liquid coloring composition. Coating 44 may preferably be accomplished by dipping the granular cores 36 in the coloring composition, e.g., by passing a perforated conveyor belt or basket supporting the granular cores 36 through a bath of coloring composition. Alternatively, the coating maybe sprayed onto the granular cores 36. The coated granular cores 36 (hereinafter “coated granules”) are then air dried 46. Drying may be accelerated by heating, e.g., by passing the coated granules on a conveyor belt through an oven/kiln. The coated granules may be agitated to promote separation of the individual granules (prevent clumping) during drying. In a preferred embodiment of the present invention, the coated granules are fired at a high temperature, e.g., 1300°-1500° Fahrenheit for a significant period of time, e.g., 2 to 24 hours. This assures that the color coating is cured and all solvent has been evaporated. The exemplary liquid coloring composition described above is water-based and therefore no apparatus need be provided to capture evaporated solvent. The granules may be agitated periodically during firing to prevent clumping and/or mechanically separated after firing to promote individuation of the granules. Depending upon the initial color of the granule and the desired end color, multiple coating 44 and drying/firing 46 steps may be performed. For example, given feldspar granules having a reflectivity of 0.28 on the ASTM C1549 solar reflectance scale using a SSR device, three coatings of coloring composition as described above, with a viscosity of 1000-20000 CPS will yield a bright white granule having a reflectivity of 0.74 suitable for producing roofing membrane having an Energy Star® rating of 0.65 to 0.74. Accordingly, at step 48, it is determined if a sufficient number of coats of the coloring composition have been applied. If not, the coated granules are recoated 44 and dried/fired 46 until a sufficient number of coats have been applied. (Multiple coats also ensure that the granule is coated over substantially the entire outer surface with coloring composition, e.g., to compensate for any bare spots that might result from incompletely coating the granules or due to declumping before or during firing. Acceptable granules should be at least 75% covered over the entirety of their outer surface and preferably 80% to 100% covered to insure high reflectivity. The coated granules are then fired 50 in an oven/kiln at a high temperature for a prolonged period of time, e.g., 1300°-1500° Fahrenheit for 2 to 24 hours.)

A hydrophobic coating (to be applied as hydrophobic layer 34) is prepared 52, having the following composition:

| Water Seal Coating | Actual | Range | Description |
|---|---|---|---|
| Water/Medium Aliphatic | 70% | 50-90% | Solution vehicle |
| oil | | | |
| Steric Acid | 25% | 8-35% | protectant for weathering |
| Parapol | 5% | 2-10% | water repellant |

The hydrophobic coating is prepared by adding and mixing the foregoing in the above-listed order.

The color coated and fired granules are then coated 54 by spraying or dipping with the hydrophobic coating and dried/fired 56. As before, the firing may be conducted at high temperatures, e.g., 1300°-1500° Fahrenheit for 2 to 24 hours. This process may be repeated to apply additional coats of hydrophobic coating 34, if desired. The finished granules 18 display a hardness of 5.0 on Mohr's mineral scale, are non-toxic, hydrophobic, bright white in color and have a reflectivity: 0.74 or 74%. As noted above, the granules are preferably graded/sized prior to coating and may be re-graded after coating. For roofing granules, a suitable granule size is 12-30 mesh. The granules 18 resulting from the foregoing process are then supplied to the processing line 58 and used to prepare roofing membrane 10.

A fabric mat 60 is supplied to the processing line 58 from a mat unwinding station 62. The mat 60 is saturated with modified asphalt in saturation tank 64, forming a composite mat 60c. The thickness of the composite mat 60c may be controlled by calendar rolls 66, which also impart smooth, flat upper and lower surfaces to the composite mat 60c. The composite mat 60c may be subjected to various processing steps, such as scraping selected areas for the application of adhesive, the application of release strips to the adhesive, etc., based upon the finished product desired. Coated granules 18 may be supplied to and dispensed by a surfacing applicator 68 onto the hot composite mat 60c, which is then cooled by a chilled water bath 70 to about 95° Celsius. The granules 18 carried on the upper surface of the composite mat 60c are then pressed into the surface thereof by press rollers 72, such that the granules 18 are embedded in the modified asphalt, which mechanically grips the granules 18, when fully cooled. The hydrophobic layer 34 on the granule 18 is compatible with the modified asphalt of layer 16 in that both are co-valent in nature, such that the asphalt adheres to the surface of the coated granules 18. Illustrating one possible roofing membrane embodiment, the bottom side of the composite mat 60c can be coated with a self-adhesive layer in coating vat 74, forming a three part laminate mat 60_{L}, which is then cooled on a cooling belt 76. The membrane then passes through an accumulator 78 and then to a winder 80, where it is cut and wound into rolls of finished roofing membrane. Release films may be inserted to prevent self-adhesive layers from bonding to an opposing surfaces of the roofing membrane when rolled into a roll. Alternatively, the roofing membrane 10 may be provided with a sand backing to prevent transfer of asphalt from the rear surface of the roofing membrane 10 to the upper granulated surface 18_{S}.

The foregoing roofing membrane 10 is flexible due to the fact that the granules 18 are each embedded (to about 50% of their extent) in the modified asphalt, but are not joined to adjacent granules 18 by an over-coating which bridges there between, as would be present with a painted-over granulated upper surface 18_{S}. The independently coated granules 18 have a stable color coating (28, 30, 32) which is not prone to cracking or degradation from bending of the roofing material, e.g., when it is rolled into rolls or bent during installation. The upper surface of the roofing membrane is reflective, having an Energy Star® rating of 0.65 to 0.74, due to the coated granules 18. This high level of reflectivity protects the roofing membrane 10 from sun damage by keeping the roofing membrane cooler, thereby avoiding degradation of the modified asphalt and softening/flow thereof. By preventing softening, the undesirable release of granules 18 from their embedded position in the asphalt 16 is also prevented, increasing the useful life of the roofing membrane 10 and preserving a reliable footing surface for workers who walk on the roof, particularly in sloped roof applications.

The hydrophobicity of the hydrophobic layer 34 on the granules 18 making up the granular surface 18_{S} of the roof membrane 10 aids in shedding water from the roof surface to prevent water infiltration and to reduce the amount of time the roof remains wet, thereby minimizing the growth of moss and other unwanted plant growth. In addition, the shedding of rainwater also reduces the exposure time of the roofing membrane 10, in particular the granules 18, from the corrosive effects of acidic rainwater, which could otherwise attack the core 36 of the granule 18, with negative implications on reflectivity and useful life of the roofing membrane. More particularly, etching of the granule 18 would alter the size/color and/or smoothness of the granules 18, leading to diminished reflectivity and granule retention. In the case of a granule having a colored coating composition, a hydrophobic coating can also shield the color composition layer(s) 28, 30, 32 from the effects of acidic rainwater.

The above-described reflective and hydrophobic granules 18 can be used in combination with a variety of roofing membranes and systems. For example, the granules 18 can be embedded in the surface of the roofing membranes described in U.S. Pat. No. 6,924,015 to Zanchetta et al., entitled, Modified Bitumen Roofing Membrane With Enhanced Sealability and/or U.S. Published Patent Application No. US 2007/0054987 to Zanchetta et al., entitled Polyethylene Modified Asphalt Compositions, each of which are incorporated herein by reference in their entirety. The granules 18 of the present invention can be utilized in conjunction with standard commercial modified asphalt roofing materials, such as APP, SBS hot-mopped, torch or self-adhered roofing membrane, roll roofing and flashing for new roofing, re-roofing, re-covering and BUR (built up roofing) repair applications (as a cap sheet). Roofing membranes 10 in accordance with the present invention may be used on flat roofs (with pedestrian access, or limited access, profiled metal decks, industrial sawtooth roofs and curved roofs.

While the present invention has been described in reference to specific embodiments thereof those with normal skill in the art may see the possibility of making variations on these embodiments without departing from the scope of the present invention. It is intended that all such variations fall within the scope of the appended claims.

We claim:

1. A roofing granule, comprising
a core having an outer surface;
a coating disposed over said outer surface.

2. The granule of claim 1, wherein said coating covers at least 80% of said outer surface of said core, forming a coated granule.

3. The granule of claim 2, wherein said coating has an associated color and a reflectivity greater than that of said core prior to coating with said coating.

4. The granule of claim 3, wherein said coating is applied as a liquid and dries to a solid layer.

5. The granule of claim 3, wherein said coating is heat-cured.

6. The granule of claim 3, wherein said coating is formed from a plurality of coats of said coating, each of said plurality of coats being separately applied and cured after application

7. The granule of claim 6, further comprising a coating of a hydrophobic material applied over said coating.

8. The granule of claim 7, wherein said hydrophobic material is substantially clear, such that the over-coated granule beneath said hydrophobic layer is visible.

9. The granule of claim 8, wherein said core is formed from a naturally occurring mineral.

10. The granule of claim 4 wherein the composition of said coating comprises in the following weight percentage ranges: water 5-40, ethylene/propylene glycol 0.1-2.0, foam master 0.1-2.0, latex polymer 7-40, natrosol 0.1-2.0, tamol 850 0.1-2.0, KTPP 0.1-2.0, titanium dioxide 2-15, zinc oxide 1-9, aluminum trihydrate 5-30, calcium carbonate 3.5-12 microns 2-15, attagel minugel 0.1-5, nuosept 95 0.1-2.0, foam master VF 0.1-2.0, latex polymer 7-40, triton 0.1-2.0, aqua ammonia 0.1-2.0, texanol 0.1-2.0, skane microbiocide 0.1-2.0, and sanicizer 0.1-2.0.

11. The granule of claim 2 wherein said coating is hydrophobic.

12. The granule of claim 11, wherein said hydrophobic coating comprises: water/medium aliphatic oil 50-90, steric acid 8-35, and parapol 2-10, said hydrophobic coating being heat curable.

13. The granule of claim 3, wherein said associated color is white.

14. A method for making roofing material, comprises the steps of:
(A) providing a plurality of granules;
(B) providing a granule coating composition;
(C) applying the coating composition to the granules to form coated granules;
(D) curing the coating composition;
(E) providing a roofing membrane with a upper deformable surface; and
(F) pressing the granules into the upper deformable surface of the roofing membrane.

15. The method of claim 14, wherein said steps of applying and curing are repeated a plurality of times and further comprising the step of coating the coated granules with a hydrophobic material.

16. The method of claim 15, wherein said step of curing is by heating and wherein said step of coating with a hydrophobic material is conducted prior to said step of pressing.

17. The method of claim 16, wherein said step of curing by heating is at a temperature exceeding 1000° Fahrenheit for a period in excess of 1 hour and further comprising the step of curing said hydrophobic material by heating prior to said step of pressing.

18. The method of claim 17, wherein said step of curing by heating the coating composition and said step of curing the hydrophobic material by heating are conducted at a temperature of between about 1300° to about 1500° for a time in a range of about 2 hours to about 24 hours.

19. A roofing membrane having an asphalt containing layer with a granular surface, comprising
a plurality of granule cores each independently coated over an outer surface thereof to encapsulate said granule cores, said coating having a reflectivity greater than the granule cores, said coated granules pressed into the asphalt containing layer to form the granular surface.

20. The roofing membrane of claim 19, wherein said coating has a plurality of layers of coloring compound, each separately applied and cured then covered by a clear hydrophobic coating that is cured.
